(19) United States
(12) Patent Application Publication
(10) Pub. No.: US 2008/0148220 A1
(43) Pub. Date: Jun. 19, 2008

(54) SYSTEM INFRASTRUCTURE STRUCTURE FORMULATION SUPPORTING SYSTEM AND SUPPORTING METHOD

(76) Inventors: MASAYUKI TABARU, Yokohama (JP); Tadashi Yamamitsu, Zama (JP); Makoto Kitagawa, Fujisawa (JP); Eiji Takamatsu, Yokosuka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/754,453

(22) Filed: May 29, 2007

(30) Foreign Application Priority Data
Dec. 14, 2006 (JP) 2006-337247

(51) Int. Cl. G06F 9/44

(52) U.S. Cl. 717/103

(57) ABSTRACT

A system infrastructure structure formulation supporting method in which based on quality requirements, formulated examples of system infrastructure structures up to the present are grouped into a database for storing the system infrastructure structures, then being stored into a group management area in advance. At the time of a new formulation, demands presented with an expression which user uses are accepted from an input/output terminal. Then, the demands are converted into quality requirements of the system by making reference to a demand-contents management table, a quality-requirement management table, and a demand-quality-requirement correspondence table stored in a reference information storage area. Next, using the quality requirements acquired, a group stored in the group management area is selected. Moreover, elements within the group are selected from a grouping table, then sequentially presenting the formulated examples having high degrees of similarity.

### INCORPORATION BY REFERENCE

The present application claims priority from Japanese application JP2006-337247 filed on Dec. 14, 2006, the content of which is hereby incorporated by reference into this application.

### BACKGROUND OF THE INVENTION

1. Field of the Invention

The present invention relates to a system infrastructure structure formulation supporting system and supporting method. More particularly, it relates to a system infrastructure structure formulation supporting system and supporting method for supporting formulation of a system infrastructure structure in technology (Infra TA: Technology Architecture) layer of Enterprise Architecture (EA).

2. Description of the Related Art

A system infrastructure structure is a concrete structure embodied and implemented by such factors as functions and performance of an information processing system which configures a system such as business system or information system. EA is a mechanism and method for improving the business system or information system of an organization such as government organization or enterprise from the viewpoint of optimization of the entire organization while focusing attention on relationship among different businesses and relationship with the information system. EA makes visualized organization and arrangement of the present status (As Is) of a business system or enterprise information system, and gives definition of a goal to be directed (To Be). Also, the framework of EA is expressed using the four-layer model where business (BA: Business Architecture) layer, data (DA: Data Architecture) layer, application (AA: Application Architecture) layer, and technology (TA) layer are related with each other.

The formulation of a system infrastructure structure in EA is performed in TA layer. Here, conventionally, the following task has been directly performed by human's handwork.

(1) Demands for the system infrastructure structure obtained from each layer of BA, DA, and AA are organized in the unit of system, application, and logical DB which are defined in AA layer.

(2) Contents of the demands are expanded into quality requirements of the systems, thereby being organized as the system quality requirement which becomes the grounds for formulating each system infrastructure structure.

(3) Each system infrastructure structure which satisfies the organized system quality requirement is formulated.

Incidentally, as prior arts concerning this kind of method for supporting the system infrastructure structure formulation in the manner of receiving demands from user, there has been known a technology disclosed in documents such as, e.g., JP-A-2005-71122. In this prior art, based on data input from designer, there is provided an example (structure draft) where the reduction ratio in environmental load becomes an optimum value at the transition from an old system to a new one.

### SUMMARY OF THE INVENTION

Conventionally, the formulation of a system infrastructure structure in EA has been directly performed by human's handwork. This handwork has required a complicated and troublesome task of making reference to a large number of documents. Also, because of differences in the experience among persons in charge of the formulation of a system infrastructure structure, formulation results of the system infrastructure structure in answer to similar demands have become different. This has resulted in formulation of a plurality of system infrastructure structures which are similar but different. As a result, it has been unsuccessful to fully accomplish the optimization as a whole which is requested by EA.

Also, the above-described prior art makes the evaluation by taking into consideration a specific function based on the user's demands, thereby making it possible to support the design of an individual system infrastructure structure. Namely, the prior art focuses attention on only an individual system, and gives no consideration to the system infrastructure structure of an entire organization. Accordingly, the prior art has a problem that it is unsuitable for the formulation of a system infrastructure structure from the viewpoint of the optimization of the entirety requested by EA.

It is an object of the present invention to solve the above-described problems in the prior art. More concretely, at the time of the formulation of a system infrastructure structure in EA, based on user's demands for the system infrastructure structure presented from each layer of EA, a formulated draft which matches and satisfies the user's demands is provided as a system infrastructure structure draft from among formulated examples obtained in the past. This method makes it possible to provide a system infrastructure structure formulation supporting system and supporting method which allows the formulation of a system infrastructure structure to be effectively supported while ensuring the optimization of the entirety.

According to the present invention, the above-described object can be accomplished by the following system infrastructure structure formulation supporting system: A system infrastructure structure formulation supporting system for supporting formulation of a system infrastructure structure based on Enterprise Architecture (EA), the formulation supporting system, including a storage device, an input/output device for inputting demands for the system infrastructure structure presented from each layer of EA, and a processing unit which an information processing device implements by executing programs stored in its main storage device, wherein the storage device stores therein a demand-contents management table for managing contents of demands from a user, a quality-requirement management table for managing quality requirement classification, term number, quality requirement contents, and value of quality requirements of the system infrastructure structure, a demand-quality-requirement correspondence table for establishing correspondences between the user's demands and the quality requirements, a hierarchical grouping table for establishing correspondences between the quality requirements and groups, and formulated examples of the system infrastructure structure split into the groups of the grouping table according to the quality requirements, the formulation supporting system, further including a group selection member for grabbing, as input data, the user's demands for the system infrastructure structure by using the input/output device, making reference to the demand-quality-requirement correspondence table from the input data so as to acquire, as input quality requirements, the quality requirements corresponding to the demands by using the processing unit, and making reference to the grouping table from the input quality requirements so as to select an already-existing group corresponding to the input quality requirements, a degree-of-similarity calculation member for calculating, by using the processing unit, degrees of similarity between formulated examples of the group and the input quality requirements, the group being selected by the input quality requirements and the group selection member, a formulated-draft presentation member for presenting, as a system infrastructure structure draft, the formulated examples within the group in a descending sequence of the degree-of-similarity calculation results based on the degree-of-similarity calculation, an example selecting question member for asking the user a narrow-down question for prompting the user to judge whether or not to narrow down the presented examples further, a group creation/update/deletion member for reflecting the formulated system infrastructure structure on the grouping table as the formulated examples of the group selected by the group selection member, and a customizing member for modifying the formulated draft in accordance with the input from the user.

According to the present invention, while ensuring the optimization of the entirety by using the determination logic for a quality requirement determined in advance and the group selection logic based on the quality requirement, the use of the degree-of-similarity calculation logic makes it possible to present an optimum formulated draft which is requested by the user. Accordingly, it becomes possible to formulate a system infrastructure structure, in which a constant design quality is maintained, without being influenced by experience of the designer. Also, it becomes possible to tremendously shorten time and labor for the formulation of the system infrastructure structure by automatically performing the processings after the demand input by using the above-described logics.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for illustrating configuration of a system infrastructure structure formulation supporting system according to an embodiment of the present invention;

FIG. 2 is a flowchart for explaining outline of processing steps of carrying out a supporting method in the system infrastructure structure formulation supporting system;

FIG. 3 is a flowchart for explaining details of a demand input/quality-requirement selection processing at a step 201 in the flowchart illustrated in FIG. 2;

FIG. 4 is a flowchart for explaining details of a group selection/degree-of-similarity calculation processing at a step 202 in the flowchart illustrated in FIG. 2;

FIG. 5 is a flowchart for explaining details of a quality requirement/system infrastructure confirmation processing at a step 203 in the flowchart illustrated in FIG. 2;

FIG. 6 is a flowchart for explaining details of a formulated-data reflection processing at a step 205 in the flowchart illustrated in FIG. 2;

FIG. 7 is a flowchart for explaining details of a degree-of-similarity calculation processing at a step 406 in the flowchart illustrated in FIG. 4;

FIG. 8 is a flowchart for explaining details of a proto-type selection processing at a step 606 in the flowchart illustrated in FIG. 6;

FIG. 9 is a flowchart for explaining details of an example retrieval result narrow-down processing at a step 409 in the flowchart illustrated in FIG. 4;

FIG. 10 is a flowchart for explaining detailed processing operation of a quality-requirement integration processing;

FIG. 11 is a diagram for illustrating a configuration example of a demand-contents management table 126 including data displayed on a display screen example illustrated in FIG. 21;

FIG. 12 is a diagram for illustrating a configuration example of a demand-quality-requirement correspondence table;

FIG. 13 is a diagram for illustrating a data configuration example of a quality-requirement-vs.-system-structure-pattern correspondence table;

FIG. 14 is a diagram for illustrating a data configuration example of a quality-requirement management table;

FIG. 15 is a diagram for illustrating a data configuration example of a top-level group management table;

FIG. 16 is a diagram for illustrating a data configuration example of a low-order-level group management table;

FIG. 17 is a diagram for illustrating a data configuration example of a grouping table;

FIG. 18 is a diagram for illustrating a data configuration example of a group split history management table;

FIG. 19 is a diagram for illustrating an example where the meaning which the groups have is clearly indicated by converting Code contents in the grouping table;

FIG. 20 is a diagram for illustrating a form at the time when elements of the groups are represented as the quality requirements;

FIG. 21 is a diagram for illustrating an example of a screen displayed on an input/output terminal for receiving demands at a step 301 in the flowchart illustrated in FIG. 3;

FIG. 22 is a diagram for illustrating an example of an inquiry display screen in a case where a question is asked of a user at a step 903 in the flowchart illustrated in FIG. 9;

FIG. 23 is a diagram for illustrating a table in which the contents are indicated by translating the notations in the demand-quality-requirement correspondence table illustrated in FIG. 12;

FIG. 24 is a diagram for illustrating an example of a screen in which a manager inputs contents where correspondences are established between the quality requirement classification and the term number of an integration source and those of an integration destination;

FIG. 25 is a diagram for explaining information which is to be exchanged between the programs and the tables at the time of the basic operation of the system infrastructure structure formulation supporting system;

FIG. 26 is a diagram for explaining information which is to be exchanged between the programs and the tables in a case where a customizing demand is made from the user;

FIG. 27 is a diagram for explaining information which is to be exchanged between the programs and the tables at the time when a newly formulated example is reflected on the grouping table; and

FIG. 28 is a diagram for explaining information which is to be exchanged between a group integration program and the tables.

### DESCRIPTION OF THE INVENTION

Hereinafter, referring to the drawings, the detailed explanation will be given below concerning embodiments of a system infrastructure structure formulation supporting system and supporting method according to the present invention.

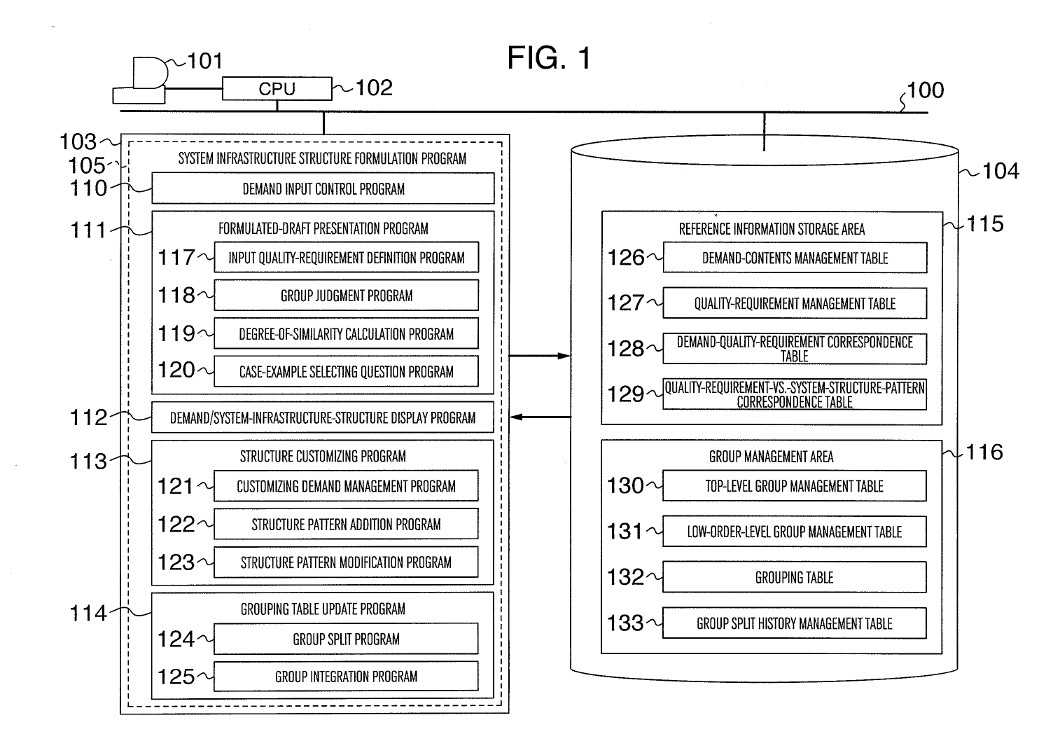

FIG. 1 is a block diagram for illustrating configuration of a system infrastructure structure formulation supporting system according to an embodiment of the present invention. In FIG. 1, the reference numerals denote following configuration components: 100 a system bus, 101 an input/output terminal, 102 an information processing device (CPU), 103 a main storage device, 104 a database, 105 a system infrastructure structure formulation program, 110 a demand input control program, 111 a formulated-draft presentation program, 112 a demand/system-infrastructure-structure display program, 113 a structure customizing program, 114 a grouping table update program, 115 a reference information storage area in the database 104, and 116 a group management area therein.

The system infrastructure structure formulation supporting system according to the embodiment of the present invention includes the input/output terminal 101, the information processing device 102, the main storage device 103, and the database 104. Moreover, as illustrated in FIG. 1, these devices are connected to each other via the system bus 100. The main storage device 103 stores thereon the respective programs of the demand input control program 110, the formulated-draft presentation program 111, the demand/system-infrastructure-structure display program 112, the structure customizing program 113, and the grouping table update program 114. These programs are executed by the CPU 102, which constructs processing function units each of which has a function to be performed.

The formulated-draft presentation program 111 includes an input quality-requirement definition program 117, a group judgment program 118, a degree-of-similarity calculation program 119, and an example selecting question program 120. The structure customizing program 113 includes a customizing demand management program 121, a structure pattern addition program 122, and a structure pattern modification program 123. The grouping table update program 114 includes a group split program 124 and a group integration program 125. These programs are executed by the CPU 102.

Also, the database 104, which is implemented by a secondary storage device such as magnetic disc, includes the reference information storage area 115 for performing reference/read of data, and the group management area 116 for performing reference/write/read of data on groups. The reference information storage area 115 stores therein a demand-contents management table 126, a quality-requirement management table 127, a demand-quality-requirement correspondence table 128, and a quality-requirement-vs.-system-structure-pattern correspondence table 129. The group management area 116 stores therein a top-level group management table 130, a low-order-level group management table 131, a grouping table 132, and a group split history management table 133. Each of the above-described tables is accessed by each of the above-described programs.

The devices in the system illustrated in FIG. 1 are connected to each other via the system bus 100. Moreover, a configuration is allowable where the information processing device 102 and the main storage device 103 are connected via a network such as the Internet or public communications network. The input/output terminal 101 may be connected to the above-described network via a network such as wireless LAN.

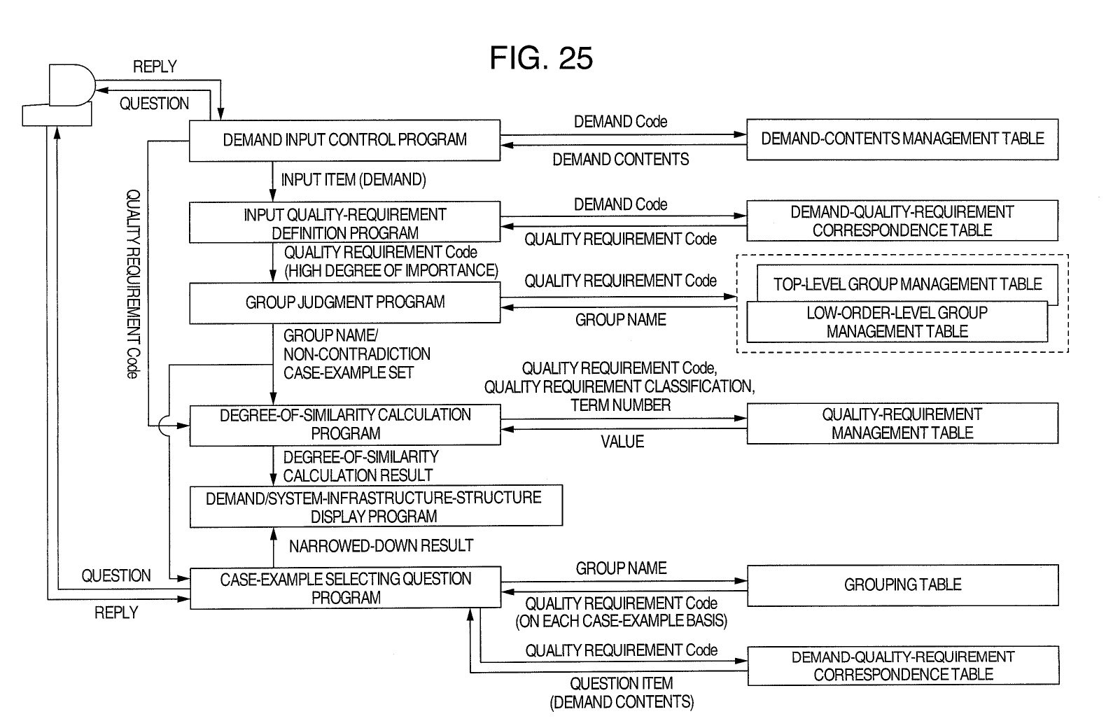

Before explaining the processing operation in the embodiment of the present invention, referring to FIG. 25 through FIG. 28, the explanation will be given below concerning the flow of information between the programs and the tables in the embodiment of the present invention explained earlier.

FIG. 25 is a diagram for explaining information which is to be exchanged between the programs and the tables at the time of the basic operation of the system infrastructure structure formulation supporting system.

First of all, the demand input control program 110 receives demand contents from the demand-contents management table 126, then displaying the demand contents on the input/output terminal 101. Judging from the displayed contents and based on resultant achieved products presented from each layer of EA, a user makes a reply by inputting a demand. The demand input control program 110 passes, to the input quality-requirement definition program 117, the demand contents which the program 110 has received from the user. The input quality-requirement definition program 117 makes reference to the demand-quality-requirement correspondence table 128 on the basis of the demand Code of the input demand, thereby acquiring a quality requirement Code then to pass the quality requirement Code to the group judgment program 118. Based on the quality requirement Code which the group judgment program 118 has received, the program 118 retrieves the top-level group management table 130 and the low-order-level group management table 131. Then, if a corresponding group exists, the program 118 receives the group name. If the corresponding group has existed, the program 118 passes the group name to the degree-of-similarity calculation program 119. Meanwhile, if the corresponding group does not exist, the program 118 selects a group which does not have a quality requirement Code that is in contradiction with the input quality requirement, then summarizing all the elements of the group into a single collection thereby to create an example set.

Based on the group presented, all the quality requirement Codes inputted, and value retained by the quality-requirement management table 127, the degree-of-similarity calculation program 119 calculates degree of similarity of each example registered within the group. The degree-of-similarity calculation program 119 passes the calculation result to the demand/system-infrastructure-structure display program 112, thereby causing the result to be displayed on the input/output terminal 101. If the user requests to narrow down the displayed result further, the example selecting question program 120 acquires, from the grouping table 132, a quality requirement Code which each example of the corresponding group has. Then, based on a quality requirement Code whose selected number-of-times is the largest, the program 120 acquires demand contents, i.e., question item, from the demand-quality-requirement correspondence table 128. Moreover, the program 120 displays the demand contents on the input/output terminal 101, thereby obtaining a reply. The example selecting question program 120 passes, to the demand/system-infrastructure-structure display program 112, a result obtained by narrowing down the examples on the basis of the reply from the user. The demand/system-infrastructure-structure display program 112 causes the result to be displayed on the input/output terminal 101.

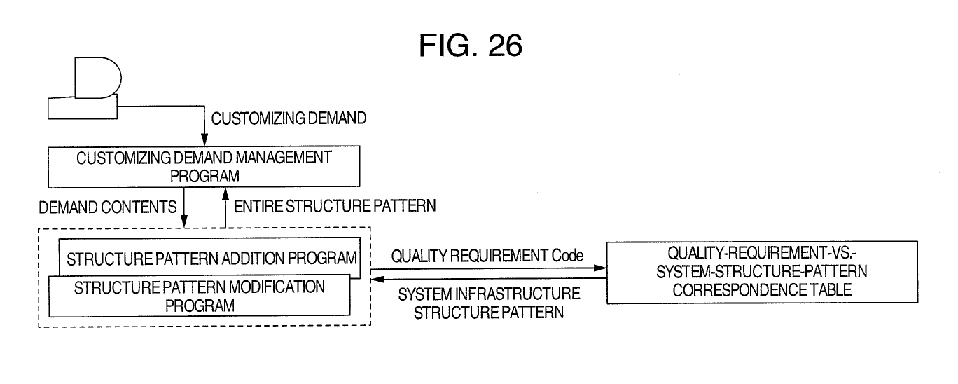

FIG. 26 is a diagram for explaining information which is to be exchanged between the programs and the tables in a case where a customizing demand is made from the user.

When the customizing demand management program 121 receives a customizing demand from the input/output terminal 101, the structure pattern addition program 122 and the structure pattern modification program 123 makes reference to the quality-requirement-vs.-system-structure-pattern correspondence table 129 on the basis of the demand contents, thereby acquiring the system infrastructure structure pattern.

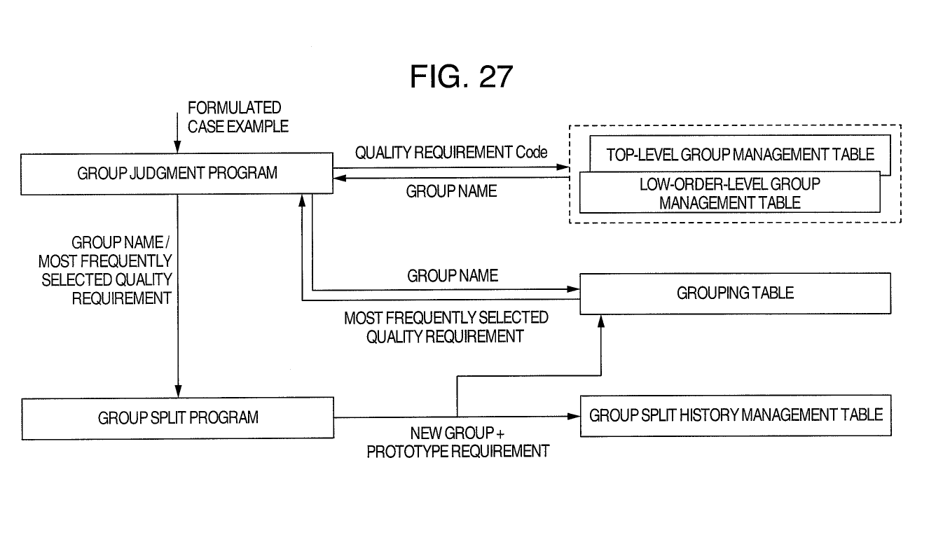

FIG. 27 is a diagram for explaining information which is to be exchanged between the programs and the tables at the time when a newly formulated example is reflected on the grouping table.

Based on the quality requirement Code, the group judgment program 118 judges to which of the already-existing groups a newly formulated example belongs. For this purpose, based on the quality requirement Code, the group judgment program 118 acquires a corresponding group name from the top-level group management table 130 and the low-order-level group management table 131. The group judgment program 118 makes reference to the grouping table 132 on the basis of the group name acquired, then counting the number of formulated examples of the group. Then, if value of the number exceeds a threshold value, the program 118 acquires quality requirement classification and term number selected most frequently of the examples of the group. Moreover, the program 118 passes the quality requirement classification and term number to the group split program 124 together with the group name. The group split program 124 updates the grouping table 132 and the group split history management table 133 by the group name and the split quality requirement classification.

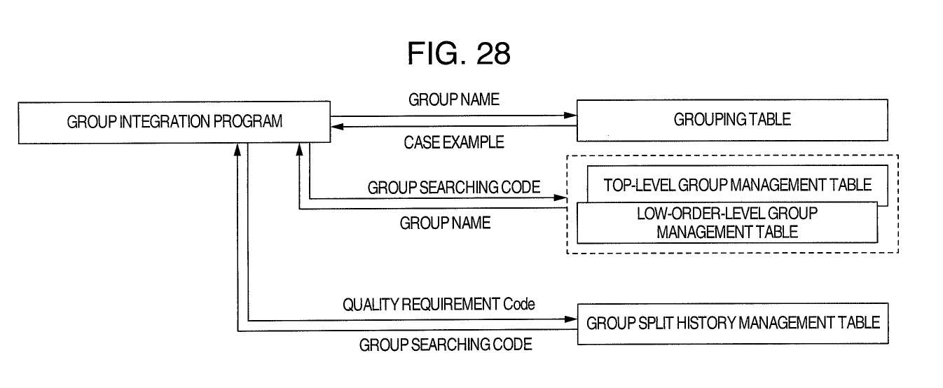

FIG. 28 is a diagram for explaining information which is to be exchanged between the group integration program 125 and the tables.

Based on the quality requirements which are inputted from the user and are to be integrated, the group integration program 125 updates the group management tables 130 and 131 at the respective levels and the group split history management table 133.

Next, the explanation will be given below concerning details of the processing operation of the system infrastructure structure formulation supporting system explained by being illustrated in FIG. 1.

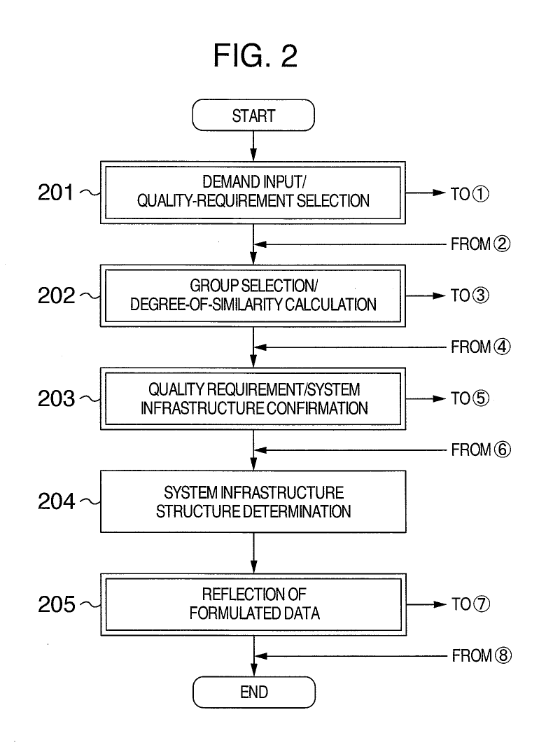

FIG. 2 is a flowchart for explaining outline of processing steps of carrying out a supporting method in the system infrastructure structure formulation supporting system. Next, the explanation will be given below regarding this flowchart.

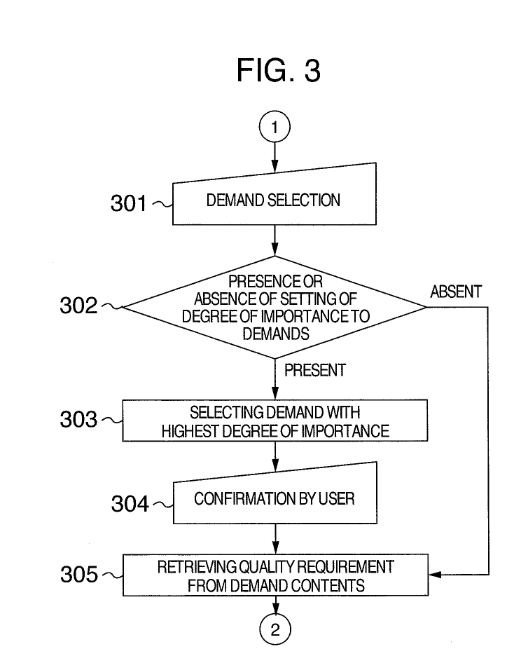

(1) First of all, the input/output terminal 101 receives, from the user, demands for the system infrastructure presented from each layer of EA, then passing the demands for the demand input control program 110. The demand input control program 110 causes the input quality-requirement definition program 117 to determine a quality requirement requested to the system infrastructure from the user's demands. Incidentally, the details of this processing will be described later referring to FIG. 3 (step 201).

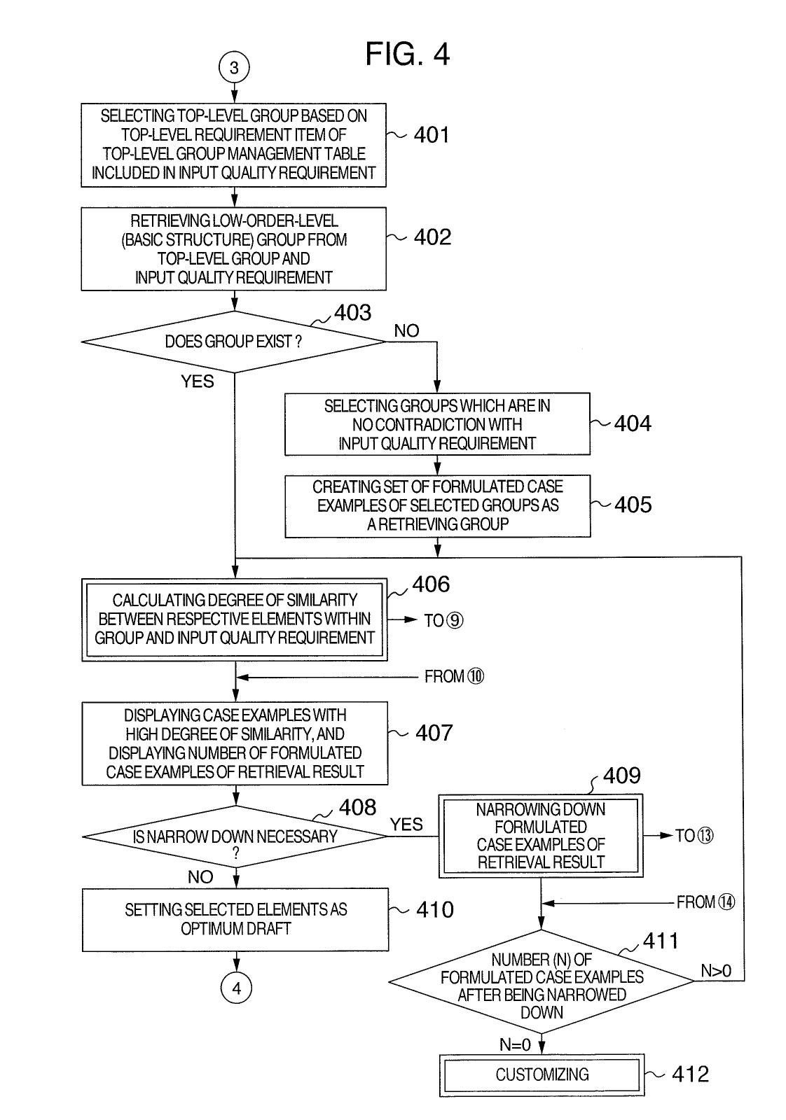

(2) Next, based on the quality requirement determined, the group judgment program 118 selects a group. Then, the program 118 causes the degree-of-similarity calculation program 119 to make the degree-of-similarity calculation with respective elements within the group. Next, the program 118 displays the calculation result to the user via the input/output terminal 101, thereby allowing the example selecting question program 120 to ask the user a narrow-down question for narrowing down the examples. Moreover, the program 118 repeats the degree-of-similarity calculation and the display in accordance with demands from the user. Incidentally, the details of this processing will be described later referring to FIG. 4 (step 202).

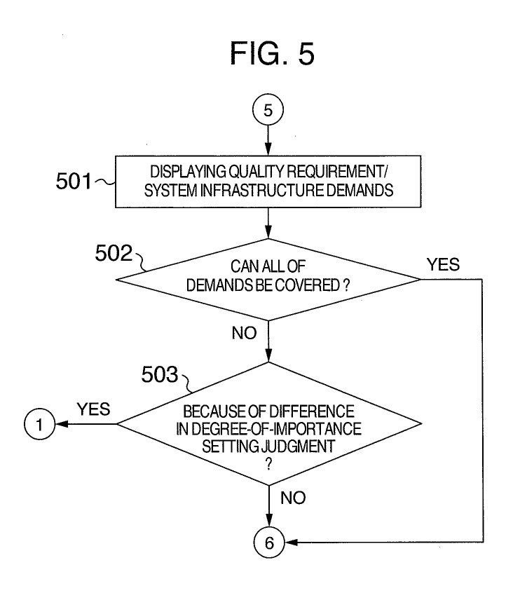

(3) Next, the demand/system-infrastructure-structure display program 112 displays, on the input/output terminal 101, demand items satisfied by a formulated draft selected by the user, thereby prompting the user to make the confirmation. If a modification is needed, the program 112 causes the structure customizing program 113 to make the customizing. Incidentally, the details of this processing will be described later referring to FIG. 5 (step 203).

(4) After that, the system infrastructure structure is determined (step 204). Finally, the processings here are terminated by performing a processing of storing the formulated result determined into the database 104 (step 205).

FIG. 3 is a flowchart for explaining details of the demand input/quality-requirement selection processing at the step 201 in the flowchart illustrated in FIG. 2. Next, the explanation will be given below regarding this flowchart.

(1) Having received, from the input/output terminal 101, the demands for the system infrastructure presented from each layer of EA and inputted by the user, the demand input control program 110 judges whether or not the degree of importance is specified and set to the demands (steps 301 and 302).

(2) If the degree of importance is specified and set to the demands in the judgment at the step 302, a demand with the highest degree of importance is selected (step 303).

(3) The input quality-requirement definition program 117 displays, on the input/output terminal 101, the demand contents and the degree of importance selected by the user, thereby prompting the user to make the confirmation. Then, if a modification is needed, the processing flow returns to and repeats the processings from the step 301 (step 304).

(4) If the confirmation by the user at the step 304 has been performed, its demand contents are determined. Also, if the degree of importance is not specified and set to the demands in the judgment at the step 302, the input contents are determined as the demand contents. Next, the demand-quality-requirement correspondence table 128 is retrieved based on the demand contents determined, then transferring to the next processing (step 305).

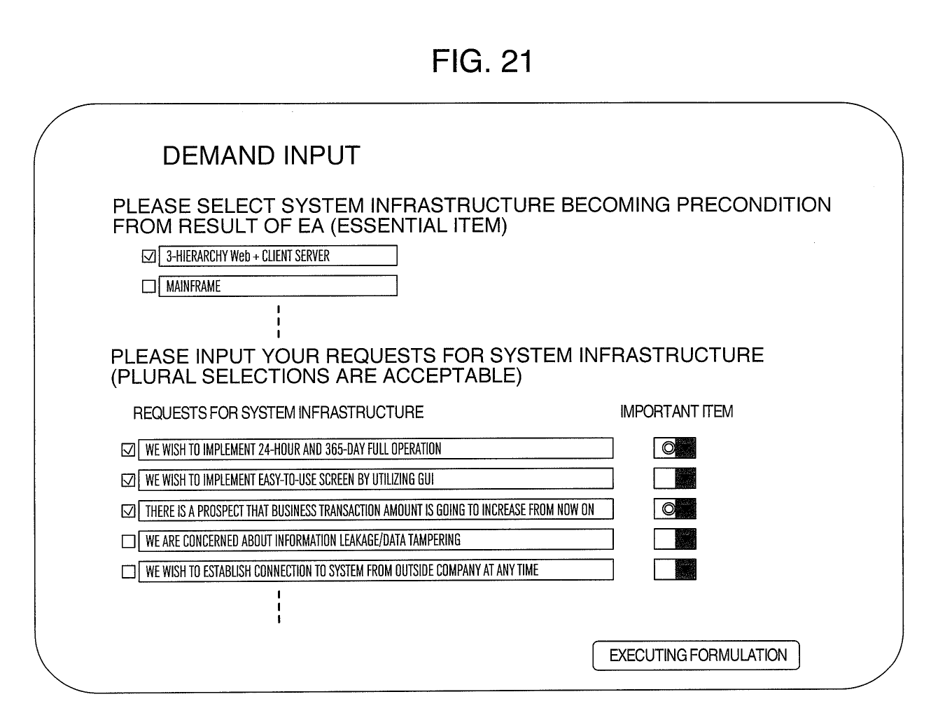

FIG. 21 is a diagram for illustrating an example of a screen displayed on the input/output terminal 101 for receiving the demands for the system infrastructure in the processing at the above-described step 301.

A method for receiving the demands for the system infrastructure in the processing at the step 301 is as follows: Namely, as illustrated in the displayed screen example in FIG. 21, the method uses check boxes and pull-downs, and receives essential items and additional items. Moreover, if the essential items are not inputted, no processing will be executed. In this processing, other methods can be used, such as a method of selecting demand items hierarchically, and a demand retrieval method by key inputting. Also, degree of importance is specified and set to each demand item by the user. The essential items, which specify the most basic structure in the formulation of a system infrastructure structure, specify an environment to be used in the user's environment from among client server and mainframe. In the EA formulation, in many cases, the basic structure is determined in advance. Also, formulation results of the system infrastructure structure become tremendously different because of differences in the basic structures. Accordingly, in the embodiment of the present invention, the basic structure is set in advance before the user is prompted to make the selection.

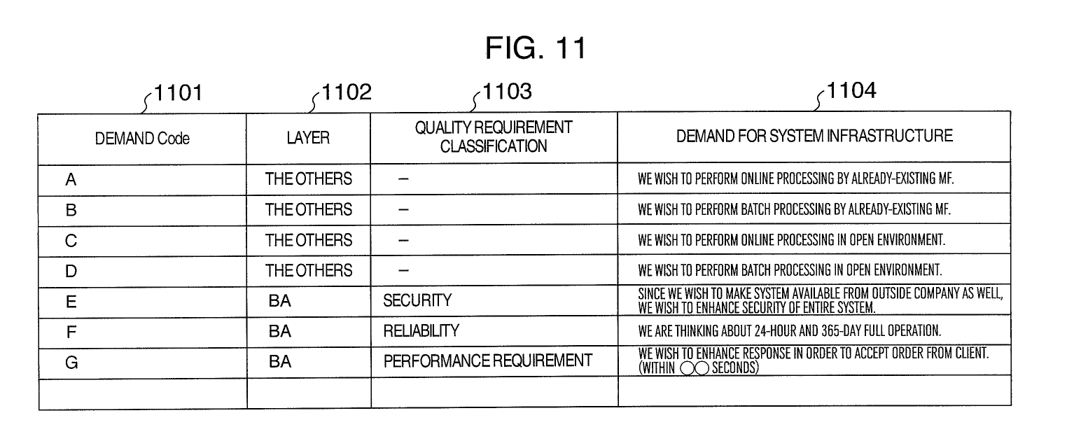

FIG. 11 is a diagram for illustrating a configuration example of the demand-contents management table 126 including the data displayed on the displayed screen example illustrated in FIG. 21.

The demand-contents management table 126 includes a plurality of records which describe respective items of demand Code 1101, layer 1102, quality requirement classification 1103, and system infrastructure demand 1104. Moreover, the item of the demand Code 1101 stores therein codes for identifying the records uniquely. The item of the layer 1102 stores therein layers in EA to which demands for the system infrastructure are presented. Also, the item of the quality requirement classification 1103 stores therein classification of the demands in the quality requirement. The item of the system infrastructure demand 1104 stores therein contents of the demands for the system infrastructure. In the example of the table illustrated in FIG. 11, the item which the user needs to select as contents of the basic structure becomes the item whose value of the demand Code 1101 is any one of A through D. The user becomes required to select one of these basic structures. The other demands are selected based on the resultant achieved product in each layer of EA. Then, the degree of importance is specified and set to each demand selected.

When performing the formulation of a system infrastructure structure, the formulation is performed based on the quality requirements for the system. The system-side words as reliability, performance, security, and usability. As a result, the user finds it difficult to judge what kind of effect will appear by regarding which quality requirement as important. One example of this judgment is that 24-hour and 365-day full operation can be implemented by implementing high reliability and high performance. Accordingly, in the embodiment of the present invention, the method is implemented which allows the user to perform the formulation of a system infrastructure structure by becoming conscious of the demand contents alone.

In the displayed screen example explained by being illustrated in FIG. 21, the user selects “3-hierarchy Web+client server” as the basic structure. Also, the user selects “We wish to implement 24-hour and 365-day full operation” and “there is a prospect that business transaction amount is going to increase from now on” as demand items of high importance, and selects “We wish to implement easy-to-use screen by utilizing GUI” as an item which is of low importance but which the user is interested in. In this way, the user becomes capable of selecting the demand items in the form of the ordinarily-used language.

In the processing in the flowchart explained in FIG. 3, the input result inputted as described earlier is displayed on the input/output terminal 101, thereby prompting the user to make the confirmation (step 304). Then, the input demand contents are determined by repeating the processings at the steps 301 to 303 depending on the requirements.

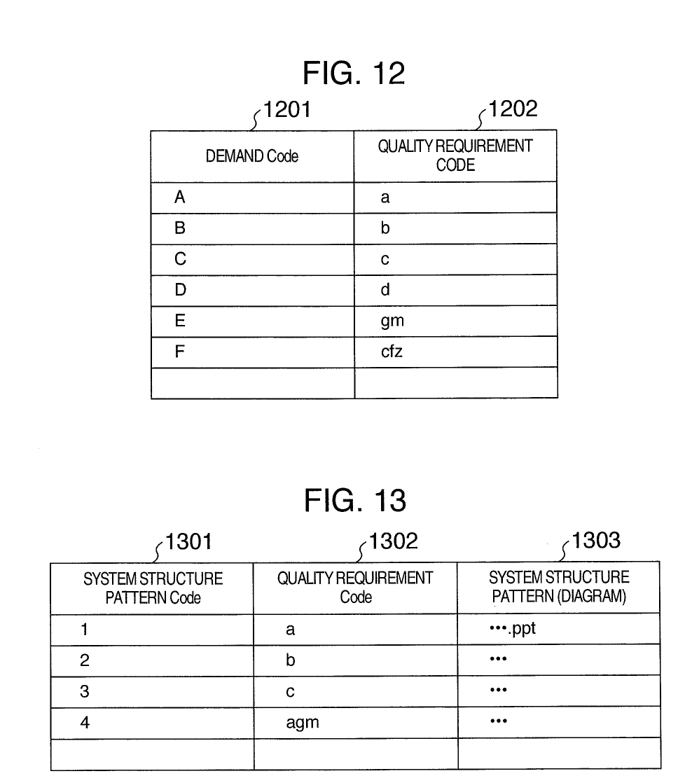

FIG. 12 is a diagram for illustrating a configuration example of the demand-quality-requirement correspondence table 128. The demand-quality-requirement correspondence table 128 includes demand Code 1201 and quality requirement Code 1202 corresponding to the demand Code 1201.

Furthermore, after the processings at the steps 303 and 304 based on the flowchart illustrated in FIG. 3, establishment of correspondences between the user's demands selected by these processings and the quality requirements is performed. The establishment of the correspondences between the user's demands and the quality requirements is performed by preparing a conversion table. This processing method is performed as follows: Namely, the quality requirement Code 1202 corresponding to the demand Code 1101 of the demand to which the highest degree of importance has been specified and set in the above-described degree-of-importance setting is retrieved by making reference to the demand Code 1201 of the demand-quality-requirement correspondence table 128 illustrated in FIG. 12 with the demand Code 1101 used as the reference key. Then, summation (set) of the quality requirement Codes 1202, i.e., the retrieval results, is calculated (step 305). If quality requirements with different design levels are selected in the same quality requirement, the quality requirement with a higher design level is selected. This processing makes it possible to determine the quality requirements by converting the user's demands to the quality requirements. The set of the quality requirements obtained by the above-described reference processing to the demand-quality-requirement correspondence table 128 will be referred to as “input quality requirement”.

The demand-contents management table 126, the demand-quality-requirement correspondence table 128, and quality requirement Code 1401 of a quality-requirement management table 127 which will be described later are used when the input result from the displayed screen illustrated in FIG. 21 explained earlier is converted into the quality requirements.

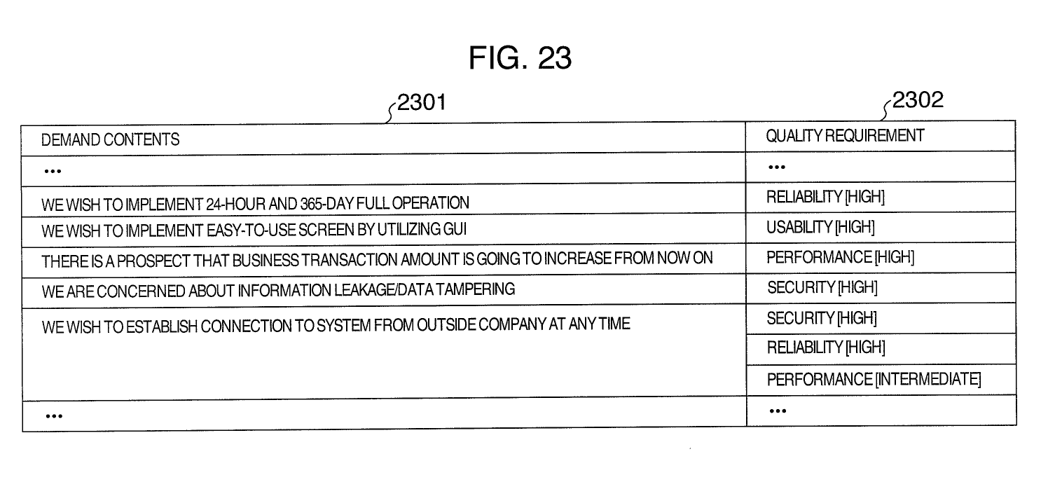

FIG. 23 is a diagram for illustrating a table in which the contents are indicated by translating the notations in the demand-quality-requirement correspondence table 128 illustrated in FIG. 12. Here, the explanation will be given below regarding configuration of this table.

In the table illustrated in FIG. 23, demand contents 2301 indicate contents which the user demands from the system infrastructure demand 1104 in the demand-contents management table 126 illustrated in FIG. 11. Also, quality requirement 2302 indicates the result obtained by making reference to the quality-requirement management table 127 using the Code in the demand-quality-requirement correspondence table 128. When the inputs explained by being illustrated in FIG. 21 are performed, quality requirements of reliability [high] and performance [high] turn out to be selected out of FIG. 23. These quality requirements are processed as quality requirement Codes such as g or z in the internal transaction.

So far, the demand input/quality-requirement selection processing at the step 201 has been terminated. Next, the processing is transferred to the group selection/degree-of-similarity calculation processing at the step 202.

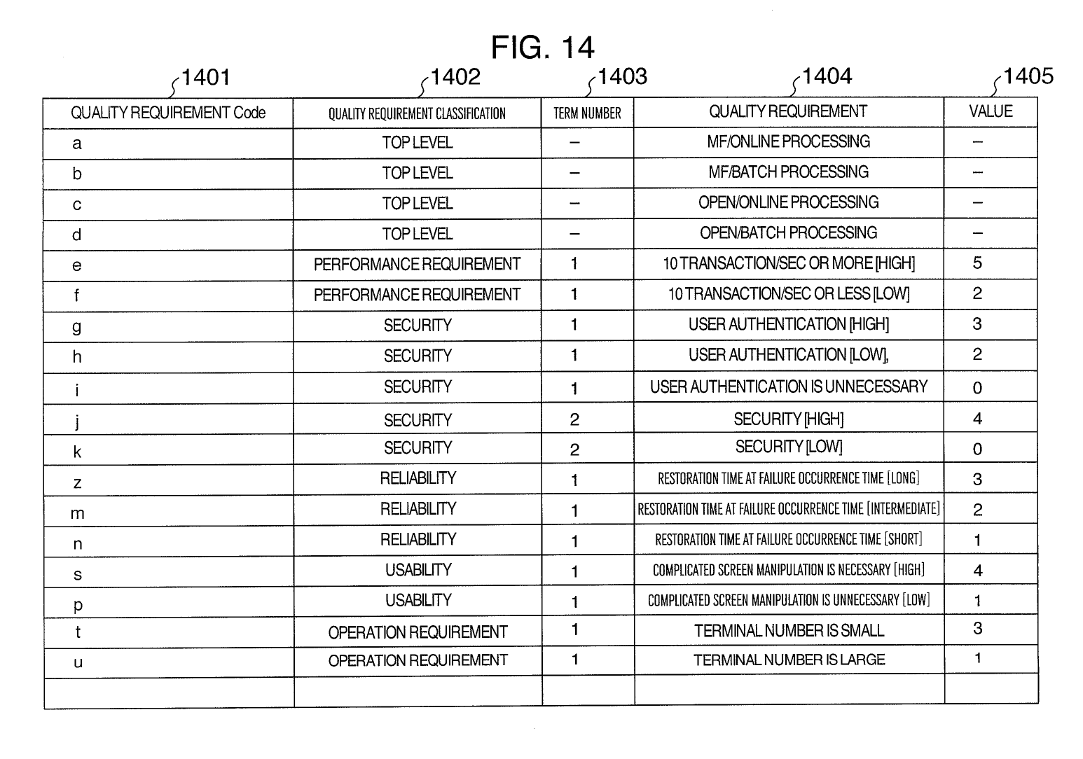

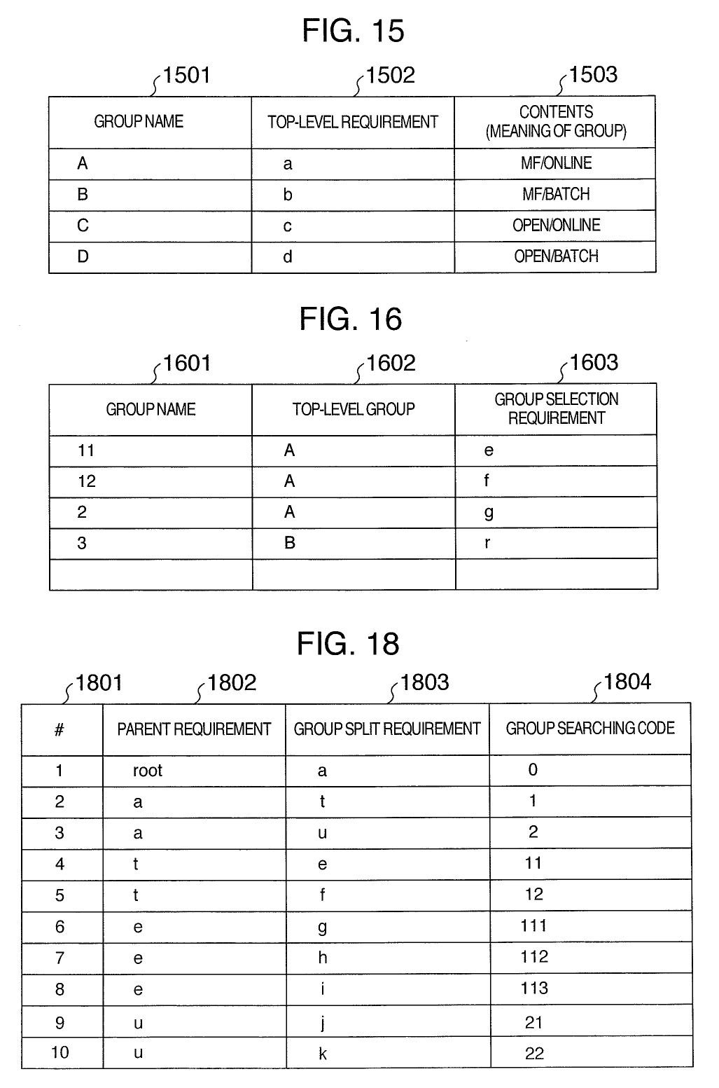

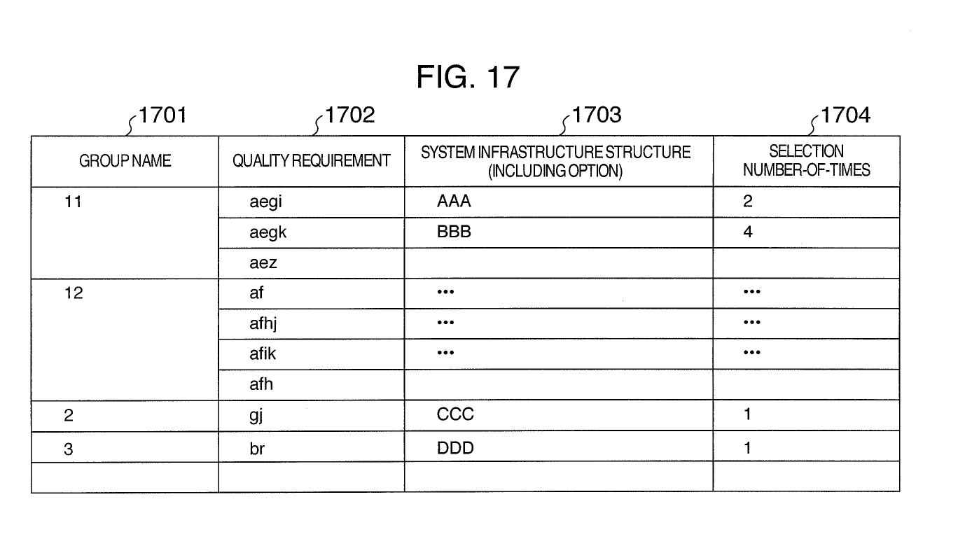

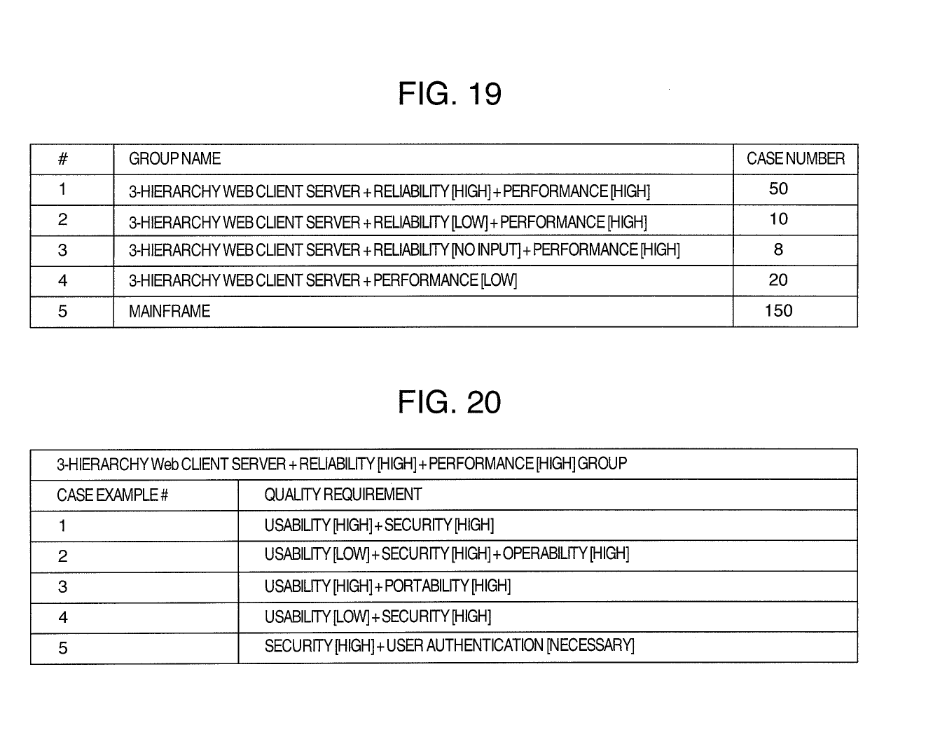

FIG. 4 is a flowchart for explaining details of the group selection/degree-of-similarity calculation processing at the step 202 in the flowchart illustrated in FIG. 2. FIG. 14 is a diagram for illustrating a data configuration example of the quality-requirement management table 127. FIG. 15 is a diagram for illustrating a data configuration example of the top-level group management table 130. FIG. 16 is a diagram for illustrating a data configuration example of a low-order-level group management table 131. FIG. 17 is a diagram for illustrating a data configuration example of the grouping table 132. FIG. 19 is a diagram for illustrating an example where the meaning which the groups have is clearly indicated by converting Code contents in the grouping table. Before explaining the flowchart of the group selection/degree-of-similarity calculation processing illustrated in FIG. 4, first, referring to FIG. 14 through FIG. 17 and FIG. 19, the explanation will be given below regarding data which is needed in the processing explained in FIG. 4.

The quality-requirement management table 127 illustrated in FIG. 14 includes a plurality of records which describe quality requirement Code 1401, quality requirement classification 1402, term number 1403, quality requirement 1404, and value 1405. Moreover, the quality requirement Code 1401 stores therein codes for identifying the records uniquely. The quality requirement classification 1402 stores therein classification items of the quality requirements. The term number 1403 stores therein sequential number on each quality requirement classification basis. The quality requirement 1404 stores therein contents of the quality requirements. The value 1405 stores therein a value indicating a difference between the quality requirements of the same quality requirement classification and the same term number. It is assumed that this value is presented by the user in advance.

The top-level group management table 130 illustrated in FIG. 15 stores therein technical classification data which becomes the infrastructure of a system. This table 130 includes a plurality of records which describe group name 1501, top-level requirement 1502, and contents 1503 describing meaning of the groups. The group name 1501 stores therein codes for identifying the records uniquely. The top-level requirement 1502 stores therein a code corresponding to the quality requirement Code 1401 of any one record stored in the quality-requirement management table 127 which will be described later. Any one of the top-level requirements 1502 is certain to be selected without fail at the time of inputting the essential terms at the step 301 in the flowchart explained in FIG. 3. The contents 1503 stores therein explanation of the groups stored in the records.

The low-order-level group management table 131 illustrated in FIG. 16 stores therein the groups which become the basic structure of a system. This table 131 includes a plurality of records which describe group name 1601, top-level group 1602, and group selection requirement 1603. The group name 1601 stores therein codes for identifying the records uniquely. The top-level group 1602 stores therein a value corresponding to any one of the group names 1501 of the top-level group management table 130. The group selection requirement 1603 stores therein a set of values corresponding to the quality requirement Code 1401 of the quality-requirement management table 127 which will be described later.

The grouping table 132 illustrated in FIG. 17 includes a plurality of records which describe group name 1701, quality requirement 1702, system infrastructure structure 1703, and selection number-of-times 1704. Moreover, the group name 1701 stores therein values corresponding to the group name 1601 of the above-described low-order-level group management table 131, and these values identify the groups. One group stores therein a plurality of elements, which are uniquely identified by the group name 1701 and the quality requirement 1702. The quality requirement 1702 stores therein a set of the above-described values corresponding to the quality requirement Code 1401 of the quality-requirement management table 127. The system infrastructure structure 1703 stores therein examples of the system infrastructure structure formulated in the past. The selection number-of-times 1704 stores therein the number-of-times in which the examples have been selected in the system infrastructure structure formulation processing up to the present.

As illustrated in FIG. 17, in the grouping table 132, the formulated examples are stored in advance in the manner of being grouped based on the quality requirement classification. As a result, in the processing which will be described later using FIG. 4, it becomes possible to retrieve at high speed the formulated examples of groups which coincide with each other. There are some cases, however, where order of the split quality requirements and degree of importance of the quality requirements determined based on the demands inputted by the user do not coincide with each other. For example, in the example illustrated in FIG. 19, the low-order groups are split into a client/server high-performance high-reliability group, a client/server high-performance low-reliability group, a client/server high-performance reliability-requirement-no-input group, and a client/server low-performance group. Here, when the quality requirement of the user's input demands client/server high-security and high-performance, the online high-performance reliability-requirement-no-input group turns out to be selected. As a consequence, an example whose security requirement is similar of the online high-performance reliability-requirement-no-input group turns out to be selected. It turns out that, however, no retrieval is made to an example whose security requirement is high and which is included in the client/server high-performance high-reliability group and the client/server high-performance low-reliability group.

Also, as illustrated in FIG. 19, the low-order groups are accumulated in the manner of being split by a certain quality requirement classification like the client/server high-performance and the client/server low-performance. This split is performed by a group update/split method which will be described later.

Next, referring to the flowchart illustrated in FIG. 4, the explanation will be given below concerning details of the group selection/degree-of-similarity calculation processing at the step 202 in FIG. 2.

(1) When this processing is started, the group judgment program 118, first, makes reference to the top-level group management table 130, thereby selecting a top-level group. Namely, as explained earlier, the quality requirement determined by the processing at the step 201 is certain to include any one of the top-level requirements 1502 of the top-level group management table 130 without fail. Accordingly, based on the input quality requirement, the group judgment program 118 selects one of the group names 1501 of the top-level group management table 130 illustrated in FIG. 15 (step 401).

(2) Next, based on the group name 1501 obtained by the processing at the step 401 and the quality requirement, the group judgment program 118 makes reference to the low-order-level group management table 131 illustrated in FIG. 16, thereby selecting a low-order-level group (step 402).

At the time of the group selection in the above-described processing, it is retrieved whether or not a group satisfying a plurality of quality requirements made to correspond to the input demands exists in the grouping table 132. In the accrual processing, each low-order-level group is processed by the group name 1601 illustrated in FIG. 16.

(3) Next, it is retrieved whether or not the corresponding group exists, and it is judged whether or not the corresponding group has existed (step 403).

(4) If, in the judgment at the step 403, the corresponding group has not existed, all of groups are selected which are in no contradiction with the quality requirement inputted by the user. Then, formulated examples which satisfy the user's demands are selected out of the selected groups. In the above-described example, the client/server groups other than the client/server low-performance group are in no contradiction with the quality requirement obtained from the user's input. Accordingly, all of the groups, i.e., the client/server high-performance high-reliability group, the client/server high-performance low-reliability group, and the client/server high-performance reliability-requirement-no-input group, turn out to be selected. Consequently, formulated examples which satisfy the user's demands, i.e., the client/server high-security and high-performance, are selected out of the formulated examples of the respective groups (step 404).

(5) Next, the formulated examples of the selected groups are retrieved. Then, all of the formulated examples are summarized, thereby regarding them as a single group. In this way, the single group is created and set as a retrieving group (step 405).

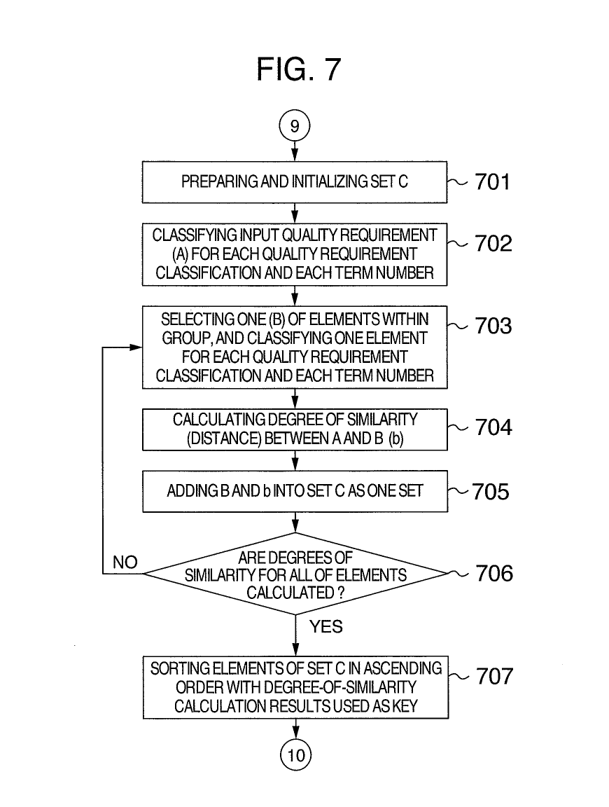

(6) Meanwhile, if, in the judgment at the step 403, the corresponding group has existed, the group is selected. Then, the degree-of-similarity calculation is made between elements within the group and the input quality requirement. Otherwise, if the retrieving group is created in the processing at the step 405, the degree-of-similarity calculation is made between the elements within the retrieving group and the input quality requirement. Incidentally, the details of this degree-of-similarity calculation processing will be described later referring to FIG. 7 (step 406).

(7) Next, as the result of the degree-of-similarity calculation in the processing at the step 406, formulated examples whose degrees of similarity are high and the number of the formulated examples within the group are displayed on the screen, thereby prompting the user to make the selection (step 407).

(8) At the time of this display at the step 407, it is judged whether or not the user has wished to narrow down the formulated examples further. If the user has not wished to narrow down the formulated examples further, the selected elements are set as the optimum draft, thereby terminating the processing here (step 408, step 410).

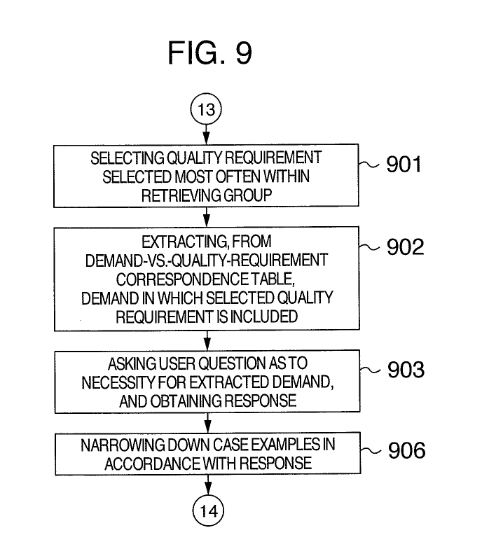

(9) Meanwhile, if, in the judgment at the step 408, the user has wished to narrow down the formulated examples further, narrowing down the formulated examples of the retrieval result is performed. Incidentally, the details of this narrow-down processing for the formulated examples of the retrieval result will be described later referring to FIG. 9 (step 409).

(10) Next, using the group obtained by the narrow-down processing for the formulated examples of the retrieval result at the step 409, the processings starting from the step 406 are performed again. In accordance with the user's demands, the narrow-down processing makes it possible to narrow down the formulated examples to a single example. However, a case is conceivable where not a single formulated example satisfies the demands inputted by the user. In view of this situation, it is judged whether the number N of the formulated examples of the retrieval result after being narrowed down is N=0 or N>0. Then, if N>0 holds, the processing operation returns to the processings starting from the step 406, thereby repeating the processings (step 411).

(11) Meanwhile, if, in the judgment at the step 411, not a single formulated example is suitable for the demands inputted by the user, i.e., if N=0 holds, a customizing processing is performed (step 412).

The above-described processing operation illustrated in FIG. 4 makes it possible to select a single formulated example which the user can regard as the optimum example.

The above-described customizing processing in the processing at the step 412 is a processing of formulating the system infrastructure structure by accumulating quality requirements corresponding to the demands inputted by the user. This customizing processing is performed using the quality-requirement-vs.-system-structure-pattern correspondence table 129 illustrated in FIG. 13.

FIG. 13 is a diagram for illustrating a data configuration example of the quality-requirement-vs.-system-structure-pattern correspondence table 129. The quality-requirement-vs.-system-structure-pattern correspondence table 129 includes respective items of system structure pattern Code 1301, quality requirement Code 1302, and system structure pattern 1303. The system structure pattern Code 1301 denotes sequential numbers for identifying the records uniquely. The quality requirement Code 1302 stores therein a set of values corresponding to the quality requirement Code 1401 of the quality-requirement management table 127 illustrated in FIG. 14. The system structure pattern 1303 stores therein a diagram for illustrating structure patterns of the system infrastructure structures structured by the quality requirement Code 1302. Taking advantage of this quality-requirement-vs.-system-structure-pattern table 129, the system structure pattern corresponding to the quality requirement inputted by the user is constructed us the structure pattern addition program 122 and the structure pattern modification program 123. This method allows implementation of the formulation of the system infrastructure structure.

FIG. 7 is a flowchart for explaining the details of the degree-of-similarity calculation processing at the step 406 in the flowchart illustrated in FIG. 4. Next, the explanation will be given below regarding this flowchart. The processing here is a processing of making the degree-of-similarity calculation by implementing establishment of the correspondences with the input quality requirement by making reference to the demand-quality-requirement correspondence table 128 with respect to all the inputted demands including demands with the low degree of importance. Incidentally, if demands at different levels exist in the same quality requirement classification, first, priority is given to the level acquired from a demand with the highest degree of importance. Also, if there exist the same quality requirement classification items of the same degree of importance but at different levels, the quality requirement at the higher level is selected.

(1) The degree-of-similarity calculation program 119, first of all, prepares and initializes a set C for storing the degree-of-similarity calculation result between the formulated examples within the group and the input quality requirement (step 701).

(2) Next, the above-described input quality requirement (referred to as “A”) and one (referred to as “B”) of the elements within the group are classified for each combination of the quality requirement classification 1402 and the term number 1403 of the above-described quality-requirement management table 127 (A={ . . . , Ai, Aj, Ak, . . . }, B={ . . . , Ba, Bb, Bc, . . . }, i, j, k, a, b, c denote sequential numbers allocated to the combination of the quality requirement classification 1402 and the term number 1403) (step 702 and step 703).

(3) Next, b=Σi |Ai−Bi|, i.e., the degree of similarity between A and B, is calculated. Moreover, B and value of the degree-of-similarity calculation result are stored into the set C, then transferring to the degree-of-similarity calculation of the next element (steps 704 through 706).

(4) After having applied the processings from the steps 704 through 706 to all of the elements within the group, the elements of the set C are sorted in an ascending order on the basis of the degree-of-similarity calculation results, thereby terminating the processing here. Incidentally, if there turn out to be a plurality of formulated examples whose degree-of-similarity calculation results become the same value, the sorting is performed such that priority is given to an element for which the degree of importance of quality requirement set in advance is larger than the other elements, and an element whose selection number-of-times is larger than the other elements (step 707).

In the above-described degree-of-similarity calculation processing, the summation of absolute values of differences in the values 1405 has been used. The calculation result of Euclid distance or vectors' inner product, however, may also be employed and defined as the degree of similarity.

Next, the explanation will be given below regarding a concrete example of the degree-of-similarity calculation. Here, it is assumed that the mainframe/online and high performance are selected as the degree-of-importance items of the input quality requirement, and that the user authentication “low” is selected as the low degree-of-importance demand.

First, in accordance with the above-described group selection processing step, the MF/online is selected from the top-level group management table 130 illustrated in FIG. 15. Accordingly, A is selected as the group name 1501. Next, the top-level group item 1602 of the low-order-level group management table 131 illustrated in FIG. 16 is retrieved using the above-described group name. Then, the group name 1601 is determined using the input quality requirement. In this case, the group 11 is selected from the value A of the top-level group item 1602 and the quality requirement e which indicates the high performance. Moreover, using this group name 1601, reference is made to the grouping table 132 illustrated in FIG. 17.

Here, let's take, as an example, the degree-of-similarity calculation between the first element within the group and the input quality requirement. Then, although the basic structure item and the high performance are unified, the demanded level for the user authentication differs therefrom. Also, the quality requirement that an antivirus measure is necessary is demanded for the formulated example. The degree-of-similarity calculation is performed for each term number of each quality requirement classification. The case where differences appear in the values is only the case of quality requirements selected at different levels. Accordingly, value calculations of the quality requirements selected at different levels are indicated here. The quality requirements selected at the different levels are the user authentication item and the antivirus measure. Consequently, values of the quality requirement items where differences are in the input requirement and the formulated example are acquired by making reference to the value field 1405 of the quality-requirement management table 127 illustrated in FIG. 14. Incidentally, if the quality requirement item appears on the one side, the calculation is made with the value on the other side set at 0. The calculation result is given as follows:

user authentication input quality requirement: 2 formulated example: 3

antivirus measure input quality requirement: 0 formulated example: 4

Making the calculation from this result using the above-described calculation expression results in the degree of similarity of the formulated example 1=|2-3|+|0-4|=5. The degrees of similarity of all of the formulated examples within the group are calculated in this way.

FIG. 9 is a flowchart for explaining the details of the narrow-down processing for the formulated examples of the retrieval result at the step 409 in the flowchart illustrated in FIG. 4. Next, the explanation will be given below regarding this flowchart.

(1) First, the quality requirements of the formulated examples within the group dealt with in the processing at the step 406 are retrieved, thereby extracting a quality requirement which is selected most often within the group (step 901).

It is assumed that, when an element within a certain group is represented by being converted into the quality requirement 1404 from the quality requirement Code 1401 of the quality-requirement management table 127 illustrated in FIG. 14, the element is structured in the form illustrated in FIG. 20. At this time, the above-described extraction processing of extracting the quality requirement will be explained as follows: Namely, when seeing sequentially the respective quality requirements indicated in the quality-requirement management table 127 illustrated in FIG. 14, the usability “high” is selected in the two formulated examples, and the user authentication “high” is selected in the two formulated examples in FIG. 20. In this way, the number is counted in which each quality requirement is selected in the formulated examples within the target group. The example indicated in FIG. 20 shows that the security “high” is selected most often. This quality requirement is judged to be the quality requirement on which a lot of users are highly likely to focus attention at present. Accordingly, this quality requirement is selected as the quality requirement for the narrow down of the formulated examples.

(2) Next, the quality-requirement item of the demand-quality-requirement correspondence table 128 illustrated in FIG. 12 is retrieved, thereby acquiring the demand item of the field which includes the extracted quality requirement in the quality-requirement item. Simultaneously, a question is asked of the user as to whether or not the acquired demand is necessary, then obtaining a response from the user. For example, it is assumed that, when the above-described security “high” is selected, the result obtained by making reference to the demand-quality-requirement correspondence table 128 is created as illustrated in FIG. 23. In this case, a question is asked of the user as to whether or not the contents, such as “We are concerned about information leakage/data tampering” and “We wish to establish connection to system from outside company at any time”, are necessary (step 902, step 903).

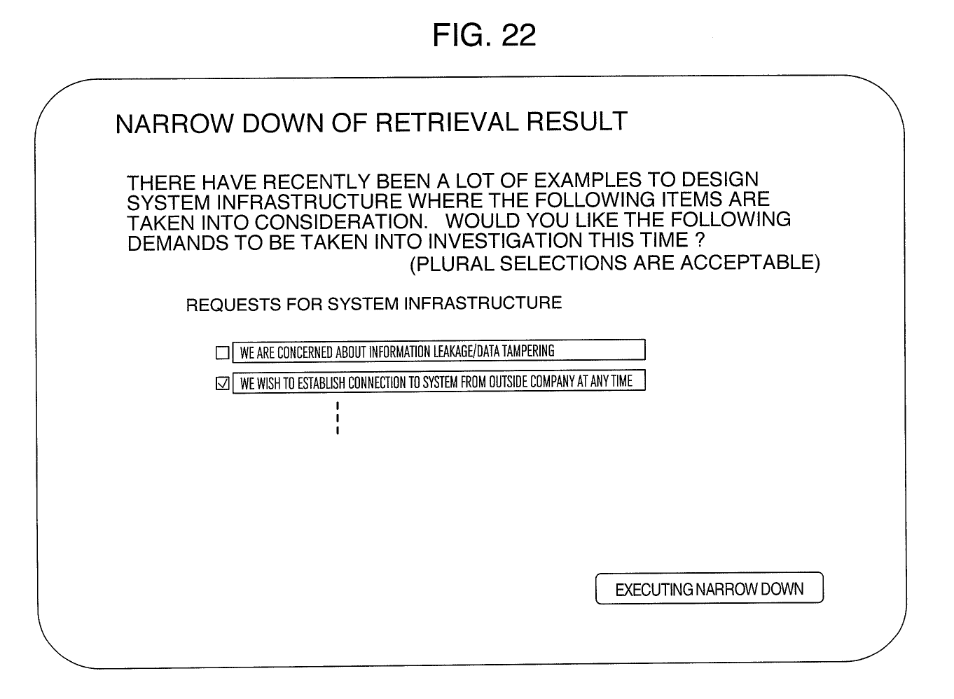

FIG. 22 is a diagram for illustrating an example of an inquiry display screen in the case where the question is asked of the user at the step 903. On this display screen, the contents of “We are concerned about information leakage/data tampering” and “We wish to establish connection to system from outside company at any time” are displayed in a selectable manner by using check boxes. The user is prompted to make a selection from among the contents. In the response to the question, if any one of the question items is checked, it is considered that the selected quality requirement is acquired as a new retrieving quality requirement. If even a single question item is not checked, it is judged that the quality requirement item is unnecessary for the user. Accordingly, a formulated example which includes none of the corresponding quality requirement is retrieved. In the narrow-down question, as long as a single question item thus asked is checked, the item is added as a new quality requirement. Consequently, in addition to the method as is illustrated in FIG. 22, the following methods are employable: Namely, a method of performing the narrow-down processing without waiting for push down of the button when one item is selected, and a method of presenting representative questions and displaying the other question items as supplemental ones.

(3) From the response result from the user as described above, a quality requirement for which he narrow down is to be performed is selected. Furthermore, the formulated examples within the above-described group are narrowed down, thereby being created and employed as a new retrieving group (step 906).

FIG. 5 is a flowchart for explaining details of the quality requirement/system infrastructure confirmation processing at the step 203 in the flowchart illustrated in FIG. 2. Next, the explanation will be given below regarding this flowchart.

(1) First, the selection of the formulated example of the system infrastructure structure or the customizing result performed at the step 201 and the step 202 is displayed on the screen. This is performed in order to prompt the user to make a confirmation as to whether or not all of the demands can be covered (step 501, step 502).

(2) If, in the user's confirmation at the step 502, all of the demands can be covered, the processing operation proceeds to the processing at the step 204. Meanwhile, if all of the demands cannot be covered, the user is prompted to make a confirmation as to whether or not the reason occurs due to a difference in the degree-of-importance setting judgment. If there is no difference in the degree-of-importance setting judgment, the processing operation proceeds to the processing at the step 204. Meanwhile, if the user does not give the approval because of the difference in the degree-of-importance setting judgment, the processing operation returns to the processings staring from the step 201, then repeating the processings (step 503).

The system infrastructure structure is formulated by the processings from the step 201 to the step 203 explained so far. Moreover, the structure of the system infrastructure is determined by the processing at the step 204. Furthermore, the update task for the group management area 116 is performed after the formulation of the system infrastructure structure.

FIG. 18 is a diagram for illustrating a data configuration example of the group split history management table 133 illustrated in FIG. 18. Here, the explanation will be given below regarding the data configuration example of the group split history management table 133.

The group split history management table 133 includes a plurality of records which describe number (#) 1801 for identifying the records uniquely, parent requirement 1802, group split requirement 1803, and group searching code 1804. Furthermore, the parent requirement 1802 and the group split requirement 1803 store therein a value or values as a set corresponding to the quality requirement Codezz 1401 of the quality-requirement management table 127. The group searching code 1804 retains the group split history. The group split history management table 133 manages the parent requirement 1802 as the codes which go around as the parent, and the group split requirement 1803 as each node, thereby storing therein the data as a tree structure.

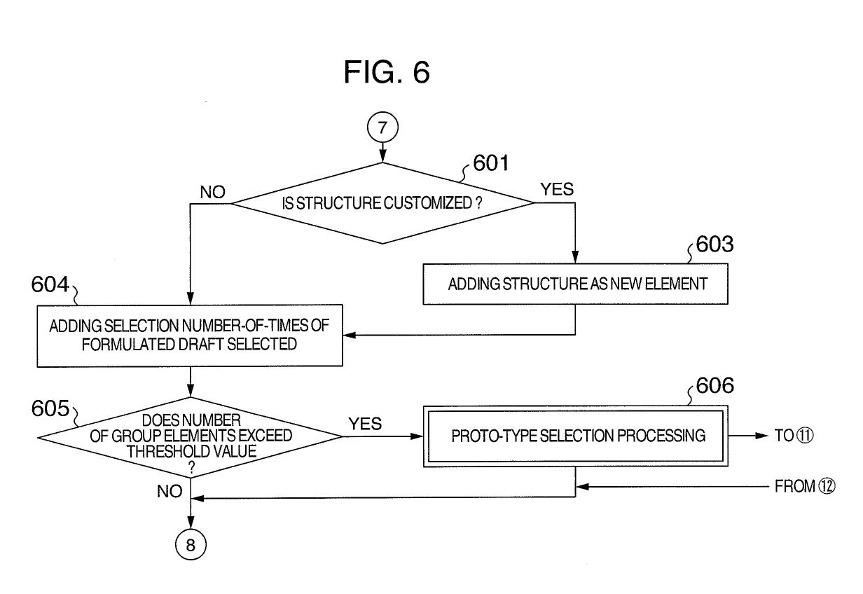

FIG. 6 is a flowchart for explaining the details of the formulated-data reflection processing at the step 205 in the flowchart illustrated in FIG. 2. Next, the explanation will be given below regarding this flowchart.

(1) First, it is judged whether or not the system infrastructure structure determined by the processing at the step 204 is the one which has been customized by the processing at the step 203 (step 601).

(2) If, in the judgment at the step 601, the system infrastructure structure has been not customized, 1 is added to the selection number-of-times 1704 of the selected formulated example of the grouping table 132 (step 604).

(3) Also, if, in the judgment at the step 601, the system infrastructure structure has been customized, based on the quality requirement which the formulated system infrastructure structure has, the system infrastructure structure is added to the already-existing group as a new pattern. Then, 1 is inputted into the selection number-of-times 1704 (step 603, step 604).

(4) Next, it is judged whether or not the number of the elements of each group has exceeded a threshold value (this threshold value may be set arbitrarily by the user) by adding the formulation result of the system infrastructure structure to the grouping table 132 in the processing at the step 604. If the number of the elements of each group has not exceeded the threshold value, the processing here is terminated. Meanwhile, if the number of the elements has exceeded the threshold value, a proto-type selection processing is performed, and the processing here is terminated (step 605, step 606).

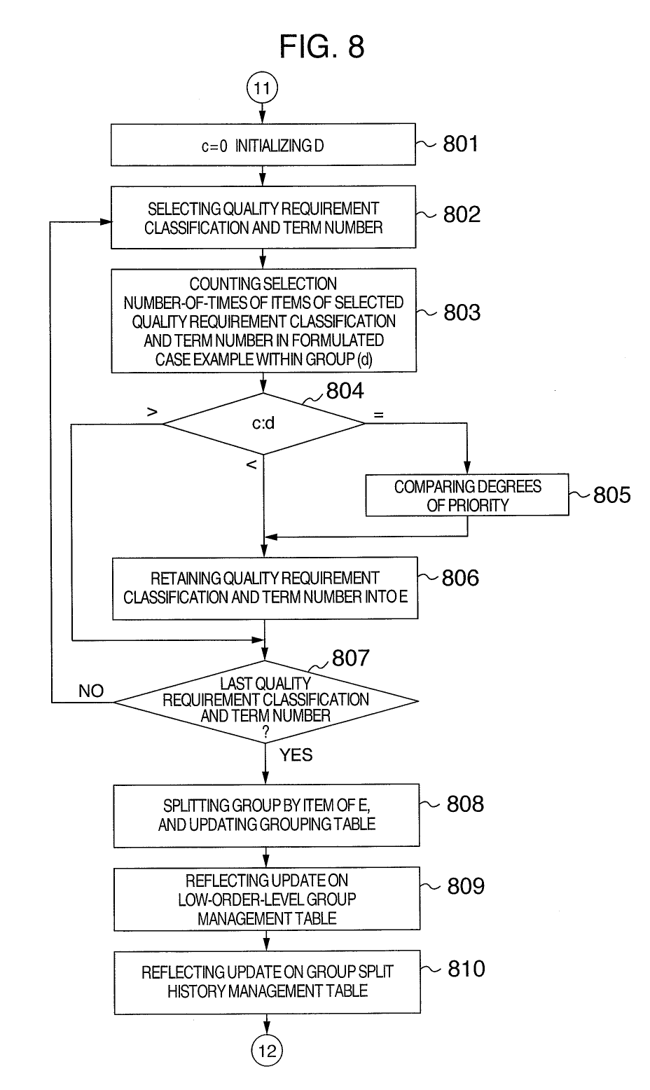

FIG. 8 is a flowchart for explaining the details of the proto-type selection processing at the step 606 in the flowchart illustrated in FIG. 6. Next, the explanation will be given below regarding this flowchart.

(1) First, a variable c=0 is set, then initializing a set D. Next, the quality requirement classification 1402 and the term number 1403 of the quality-requirement management table 127 illustrated in FIG. 14 are selected (step 801, step 802).

(2) Next, the selection number-of-times in the corresponding group of the quality requirement classification 1402 and the term number 1403 selected at the step 802 is counted. Moreover, the resultant value counted is denoted by d, then making the comparison between c and d (step 803, step 804).

(3) In the comparison between the values of c and d at the step 803, if the values of c and d are equal to each other, in order to represent that there has existed the combination of the quality requirement classification and the term number both of which have the same selection number-of-times, the comparison is made between the degree of importance of a quality requirement classification retained as a temporary set E and the degree of importance of the quality requirement classification selected at the step 803. Furthermore, the quality requirement classification with the higher degree of importance is selected, then being retained into the set E (step 805, step 806).

(4) Next, in the comparison between the values of c and d at the step 803, if the value of c is smaller than the value of d, the quality requirement is the quality requirement whose selection number-of-times has been the largest of the judgments so far. Accordingly, the quality requirement classification 1402 and the term number 1403 selected at the step 803 are retained into the set E (step 806).

(5) After the processing at the step 806, or if the value of d is smaller than the value of c in the comparison between the values of c and d at the step 803, in order to represent that there has existed the quality requirement whose selection number-of-times has been larger of the judgments so far, the processing operation transfers to the next processing directly. Then, it is judged whether or not all of the processings at the steps 802 through 804 and the processings at the steps 805 and 806 transitioned from the judgment at the step 804 have been terminated with respect to all of the quality requirement classification 1402 and the term number 1403. Namely, it is judged whether or not the processings of the last quality requirement classification and the last term number have been terminated. If all of the processings with respect to all of the quality requirement classification 1402 and the term number 1403 have been not terminated, the processing operation returns to the processings starting from the step 802, then continuing the processings (step 807).

(6) Meanwhile, if, in the judgment at the step 807, all of the processings with respect to all of the quality requirement classification 1402 and the term number 1403 have been terminated, the quality requirement classification 1402 which has been selected most often of the formulated examples within the group is stored in the set E. Accordingly, the group is split using the quality requirement Code 1401 which belongs to the quality requirement classification 1402 and the term number 1403 stored in the set E. Then, the grouping table 132 illustrated in FIG. 17 is updated using the split contents. Updating the grouping table 132 is implemented by attaching the sequential number corresponding to the split number behind the already-existing group name 1701 (step 808).

(7) Based on the updated contents of the grouping table 132, the low-order-level group management table 131 illustrated in FIG. 16 is updated. Updating the low-order-level group management table 131 is performed by the group name 1601 whose contents are basically the same as the contents updated at the step 808. Concretely, the update is performed by adding and storing, into the group selection requirement 1603, the quality requirement Code 1401 included in the quality requirement classification 1402 and the term number 1403 selected in the processing at the step 808 (step 809).

(8) Next, the group split history management table 133 illustrated in FIG. 18 is updated. Updating the group split history management table 133 is performed as follows: Namely, first, based on the group name 1701 of the corresponding group, the group searching code 1804 of the group split history management table 133 illustrated in FIG. 18 is searched for, thereby acquiring the group split requirement 1803 of the corresponding record. Next, the group split requirement 1803 acquired in this method is stored into the parent requirement 1802. Moreover, each quality requirement Code 1401 included in the quality requirement classification 1402 and the term number 1403 selected at the step 808 is stored into the group split requirement, thereby creating a new record where the group name to which basically the same processing as the processing at the step 809 is applied is stored into the group searching code 1804 (step 810).

As described earlier, the quality requirement to be split is selected from the tendency of the quality requirements included in the examples formulated up to the present. This method makes it possible to enhance a probability that there exists a group which coincides with the demands inputted by the user in the group selection processing described earlier.

In the foregoing description, the explanation has been given concerning presentation of the formulated examples of the system infrastructure structure and the method for updating the database of the formulated examples. By the way, the situation in which the system infrastructure is positioned is changing day after day. Accordingly, it is conceivable that the quality requirements demanded for the system infrastructure structure by environmental change (such as legal regulation) and technological innovation are also going to change. On account of this, it is conceivable that using the already-existing formulated examples may become impossible. However, the information on the examples based on which the system infrastructure structure is formulated can become useful information. This fact requires that the examples up to the present be made continuously available by updating the examples into a classification which is suitable for a new environment. This is performed by modifying the database and the quality-requirement management table which manage the formulated examples in response to the environmental change. The embodiments of the present invention allow such a processing as well. Since this processing is executed not by the system user but by the system manager, the quality requirements are used.

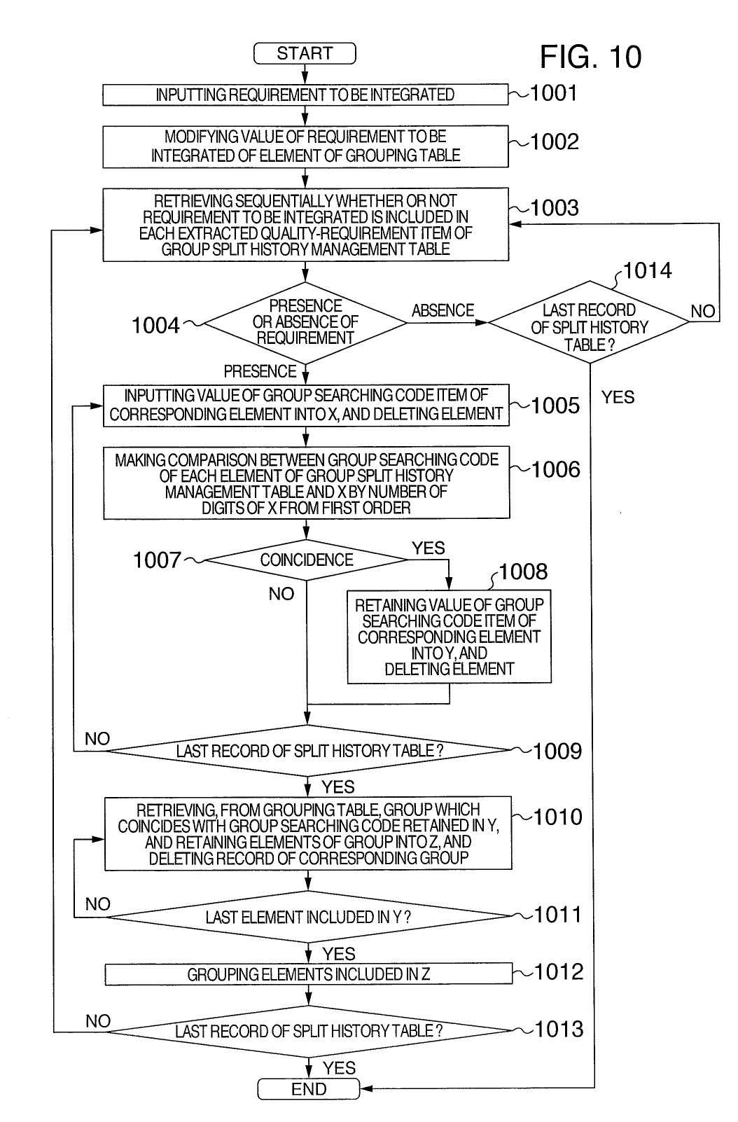

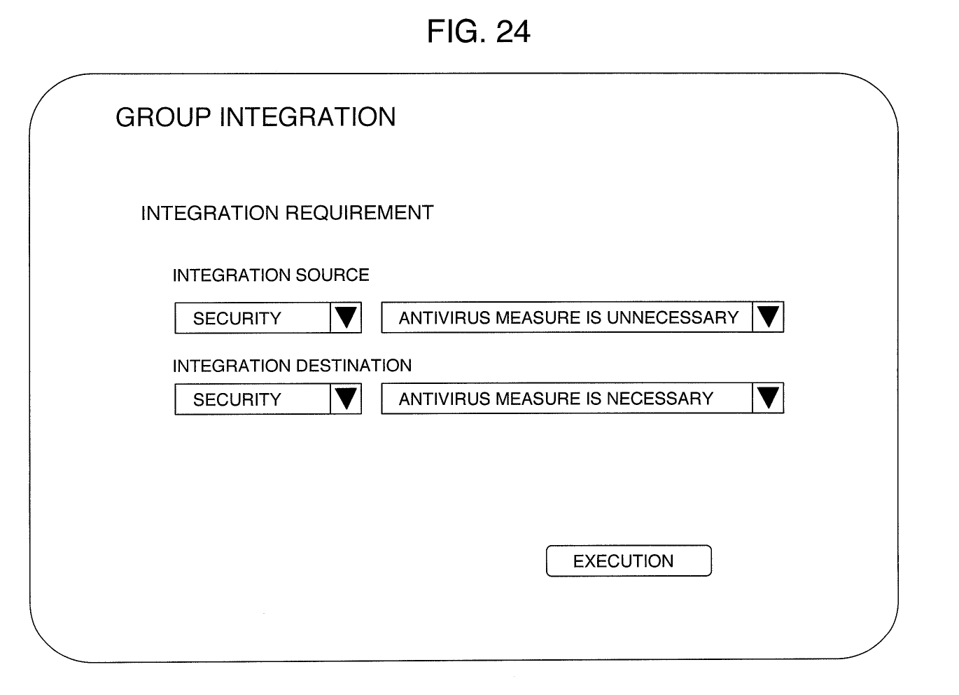

FIG. 10 is a flowchart for explaining detailed processing operation of a quality-requirement integration processing. FIG. 24 is a diagram for illustrating an example of a screen in which the system manager inputs contents where correspondences are established between the quality requirement classification and the term number of an integration source and those of an integration destination. Referring to these drawings, the explanation will be given below concerning the quality-requirement integration processing which allows the examples up to the present to be made continuously available by updating the examples into a classification which is suitable for a new environment.

(1) First, the system manager, from the display screen illustrated in FIG. 24, inputs contents where correspondences are established between the quality requirement classification and the term number of an integration source and those of an integration destination. Then, the manager presses an execution button, thereby starting this processing (step 1001).

(2) The group integration program 125 makes reference to each element of the quality requirement 1702 of the grouping table 132, then modifying the quality requirement Code of the above-described integration source to the quality requirement Code of the above-described integration destination (step 1002).

(3) Next, the group integration program 125 makes reference to each element of the group split requirement 1803 of the group split history management table 133 illustrated in FIG. 18. Then, the program 125 retrieves sequentially whether or not the quality requirement classification Code of the integration source is included in each element, thereby judging whether or not the requirement exists therein (step 1003 and step 1004).

(4) If, in the judgment at the step 1004, the information on the integration source exists, the value of the group searching code 1804 of the corresponding element is temporarily stored as X, and the record is deleted. Next, reference is made to the group searching code 1804 of the group split history management table 133. Then, the comparison is made between the group searching code and X by the number of digits of X, thereby judging whether or not the group searching code and X coincide with each other (steps 1005 through 1007).

(5) If, in the judgment at the step 1007, the group searching code and X coincide with each other, the value of the group searching code 1804 of the corresponding group is temporarily retained as Y, and the element is deleted (step 1008).

(6) If, in the judgment at the step 1007, the group searching code and X do not coincide with each other, or, after the processing at the step 1008, it is judged whether or not, regarding all of the split history records, the processings at the steps 1005 through 1007 and the processing at the step 1008 transitioned from the judgment at the step 1007 have been executed with respect to all of the elements. Namely, it is judged whether or not the processings have been performed up to the last record of the group split history management table. If the processings up to the last record have been not terminated, the processing operation returns to the processings starting from the step 1005, then repeating the processings (step 1009).

(7) Next, reference is made to the group name 1701 of the grouping table 132, thereby retrieving the quality requirement 1702, the system infrastructure structure 1703, and the selection number-of-times 1704 of a record which coincides with the group name retained in Y. Then, elements of the group retrieved are temporarily stored as Z, and the record of the corresponding group is deleted (step 1010).

(8) Next, it is judged whether or not the processing at the step 1010 has been terminated with respect to all of the elements included in Y. Then, if the processing has been not terminated, the processing operation returns to the processing at the step 1010, then performing the processing at the step 1010 with respect to all of the elements included in Y (step 1011).

(9) If, in the judgment at the step 1011, the processing at the step 1010 has been terminated with respect to all of the elements included in Y, the processings at the steps 401 through 402 explained using FIG. 4 are performed with respect to the elements included in Z, thereby re-grouping the elements (step 1012).

(10) It is judged whether or not the processings at the steps 1003 through 1012 have been terminated up to the last record of the group split history management table 133. Then, if the processings have been not terminated, the processing operation returns to the processings starting from the step 1003, then repeating the processings. Meanwhile, if the processings have been terminated, the processing here is terminated (step 1013).

It should be further understood by those skilled in the art that although the foregoing description has been made on embodiments of the invention, the invention is not limited thereto and various changes and modifications may be made without departing from the spirit of the invention and the scope of the appended claims.

1. A system infrastructure structure formulation supporting system for supporting formulation of a system infrastructure structure based on Enterprise Architecture (EA),
said formulation supporting system, comprising:
a storage device,
an input/output device for inputting demands for said system infrastructure structure presented from each layer of EA, and
a processing unit which an information processing device implements by executing programs stored in its main storage device, wherein
said storage device stores therein a demand-contents management table for managing contents of demands from a user, a quality-requirement management table for managing quality requirement classification, term number, quality requirement contents, and value of quality requirements of said system infrastructure structure, a demand-quality-requirement correspondence table for establishing correspondences between said user's demands and said quality requirements, a hierarchical grouping table for establishing correspondences between said quality requirements and groups, and formulated examples of said system infrastructure structure split into said groups of said grouping table according to said quality requirements,
said formulation supporting system, further comprising:
group selection means for grabbing, as input data, said user's demands for said system infrastructure structure by using said input/output device, making reference to said demand-quality-requirement correspondence table from said input data so as to acquire, as input quality requirements, said quality requirements corresponding to said demands by using said processing unit, and making reference to said grouping table from said input quality requirements so as to select an already-existing group corresponding to said input quality requirements,
degree-of-similarity calculation means for calculating, by using said processing unit, degrees of similarity between formulated examples of said group and said input quality requirements, said group being selected by said input quality requirements and said group selection means,
formulated-draft presentation means for presenting, as a system infrastructure structure draft, said formulated examples within said group in a descending sequence of said degree-of-similarity calculation results based on said degree-of-similarity calculation,
example selecting question means for asking said user a narrow-down question for prompting said user to judge whether or not to narrow down said presented examples further,
group creation/update/deletion means for reflecting said formulated system infrastructure structure on said grouping table as said formulated examples of said group selected by said group selection means, and
customizing means for modifying said formulated draft in accordance with said input from said user.

2. The system infrastructure structure formulation supporting system according to claim 1, wherein
said storage device stores therein a top-level group management table classified by basic technology of said system infrastructure structure, a low-order-level (basic structure) group management table classified by said top-level group and said basic technology of said system infrastructure structure, and said grouping table for accumulating therein individual system infrastructure structure examples based on said classification of said low-order-level group management table,
said group selection means, based on said input quality requirements, making reference to said top-level group management table, said low-order-level group management table, and said grouping table stored in said storage device in a sequence of degrees of importance of said input quality requirements, or, if no corresponding group exists,
said group selection means selecting a group which is in no contradiction with said input quality requirements, and setting said group as a retrieval target group.

3. The system infrastructure structure formulation supporting system according to claim 1, wherein
said degree-of-similarity calculation means
makes reference to said quality-requirement management table with respect to quality requirement of one element of said group and said input quality requirements, said group being selected by said group selection means based on said input quality requirements,
acquires, from said value field of said quality-requirement management table, value of said one element of said group and value of said input quality requirements for each quality requirement classification item, and calculates said degree of similarity using said respective values, and
compares results obtained by similarly calculating said degrees of similarity with respect to all of elements within said group, and presents said examples in a descending sequence of said degrees of similarity.

4. The system infrastructure structure formulation supporting system according to claim 1, wherein
said example selecting question means
presents said examples of said high degrees of similarity presented by said degree-of-similarity calculation means, and number of said corresponding examples selected by said group selection means, and prompts said user to judge said presence or absence of said narrow down,
creates, if said narrow down is necessary, a narrow-down question item from said quality requirements selected by said formulated examples up to the present included in said grouping table, and asks said user said narrow-down question, and
narrows down said corresponding examples in accordance with said response from said user.

5. The system infrastructure structure formulation supporting system according to claim 1, wherein
said group creation/update/deletion means comprises new-group creation means, said new-group creation means adding a formulated example into said grouping table, and splitting a group thereby to create new groups in said grouping table if number of formulated examples within said group becomes larger than a predetermined value,
said group creation/update/deletion means storing information into a group split history management table created in said storage device, said information being split by said new-group creation means.

6. The system infrastructure structure formulation supporting system according to claim 5, wherein
said group creation/update/deletion means
grabs, as input data, quality requirement of an integration source and quality requirement of an integration destination from said input/output device, judges whether or not value of said quality-requirement field of said grouping table partially coincides with said quality requirement of said integration source, and rewrites value of coincident portion of said quality-requirement field to said quality requirement of said integration destination, and
makes reference to said group split history management table,
acquires a group searching code of a record in which value of said group split requirement field coincides with said quality requirement of said integration source, and
retrieves, from other records of said group split history management table, value of said group searching code of said record and a record in which value of said group searching code by the number of digits thereof coincides with said group searching code, and
acquires said group searching code of said corresponding record and deletes said corresponding record, and
makes reference to said grouping table, retrieves a group in which said group-name field coincides with said group searching code, and retains elements of said corresponding group and deletes said corresponding record, and
stores said retained elements such that said retained elements are grouped by said group creation/update means.

7. The system infrastructure structure formulation supporting system according to claim 1, wherein
said customizing means, based on said system infrastructure structure draft presented by said formulated-draft presentation means, adds a new structure thereto in a manner of becoming suitable for user environment,
said customizing means then storing, into said grouping table, said contents of said system infrastructure structure formulated by said group selection means.

8. A system infrastructure structure formulation supporting method for supporting formulation of a system infrastructure structure based on Enterprise Architecture (EA),
said formulation supporting method, including:
a storage device,
an input/output device for inputting demands for said system infrastructure structure presented from each layer of EA, and
a processing unit which an information processing device implements by executing programs stored in its main storage device, wherein
said storage device stores therein a demand-contents management table for managing contents of demands from a user, a quality-requirement management table for managing quality requirement classification, term number, quality requirement contents, and value of quality requirements of said system infrastructure structure, a demand-quality-requirement correspondence table for establishing correspondences between said user's demands and said quality requirements, a hierarchical grouping table for establishing correspondences between said quality requirements and groups, and formulated examples of said system infrastructure structure split into said groups of said grouping table according to said quality requirements,
said formulation supporting method, comprising the steps of:
grabbing, as input data, said user's demands for said system infrastructure structure by using said input/output device, making reference to said demand-quality-requirement correspondence table from said input data so as to acquire, as input quality requirements, said quality requirements corresponding to said demands by using said processing unit, and making reference to said grouping table from said input quality requirements so as to select an already-existing group corresponding to said input quality requirements,
calculating, by using said processing unit, degrees of similarity between formulated examples of said group and said input quality requirements, said group being selected by said input quality requirements and said group selection means,
presenting, as a system infrastructure structure draft, said formulated examples within said group in a descending sequence of said degree-of-similarity calculation results based on said degree-of-similarity calculation,
asking said user a narrow-down question for prompting said user to judge whether or not to narrow down said presented examples further,
reflecting said formulated system infrastructure structure on said grouping table as said formulated examples of said group selected by said group selection means, and
customizing said formulated draft by modifying said formulated draft in accordance with said input from said user.
